(19) United States
(12) Patent Application Publication
(10) Pub. No.: US 2007/0079939 A1
(43) Pub. Date: Apr. 12, 2007

(54) Adhesive tape joining apparatus

(75) Inventors: Osamu Degawa, Osaka (JP); Shinsuke Ikishima, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: NITTO DENKO CORPORATION

(21) Appl. No.: 11/541,729

(22) Filed: Oct. 3, 2006

(30) Foreign Application Priority Data
Oct. 4, 2005 (JP) JP2005-291158
Mar. 7, 2006 (JP) JP2006-061203

(51) Int. Cl. B44C 7/00

(52) U.S. Cl. 156/574; 156/577

(57) ABSTRACT

A separator guide face for guiding a separator which is peeled off an adhesive tape at a region where the tape is wound of a tape supply roller in a direction different from a tape joining and moving direction is formed on a separator guide arranged to be opposed to a tape supply roller, and the separator guide can be changed between a posture for a separator guiding operation posture opposed to the tape supply roller and a release posture which is largely separated from the tape supply roller 12.

### BACKGROUND OF THE INVENTION

(1) Field of the Invention

The present invention relates to an adhesive tape joining apparatus used when an adhesive tape is joined to a curved workpiece such as a door sash of an automobile.

(2) Description of the Related Art

In recent years, in a manufacturing process of an automobile, in place of black coating processing on a door sash, a technology to join a black adhesive tape has been developed. For example, an adhesive tape joining apparatus (an adhesive tape joining jig) has been suggested. Herein, an adhesive tape from which a separator is separated is elastically pressed against a tape joining face with a joining roller to be joined thereto while guiding and moving this adhesive tape joining apparatus on hand along a workpiece (for example, refer to JP-A 2001-115117).

This adhesive tape joining apparatus (the adhesive tape joining jig) is provided with four bottom guide rollers to be engaged on back and forth and right and left of a bottom face that is a tape joining face of the workpiece and four side guide rollers to be engaged on back and forth two places of the right and left side faces of the workpiece at its base. In addition, a single pressing roller to be elastically pressed against the upper face of the workpiece is mounted on a pressing lever that is pivotally connected to the base. Then, a bottom guide roller group and the pressing roller sandwich the workpiece vertically so as to keep the posture of the adhesive tape joining apparatus with respect to the workpiece. Further, by engaging the side guide rollers from right and left of the workpiece, positioning in a right and left direction of the adhesive tape joining apparatus with respect to the workpiece has been made.

Thus, moving the adhesive tape joining apparatus of which position and posture are determined along a workpiece F due to the guidance of engagement by the roller group, the adhesive tape is elastically pressed against the bottom of the workpiece by an elastic roller arranged at the rear end of the base to be joined thereto. In addition, the adhesive tape to be supplied is curved and guided ahead of the elastic roller. In this case, the separator is separated to be fed forward in a joining moving direction through a gap formed between the base and a sliding plate.

In other words, in the suggested adhesive tape joining apparatus, the separated separator is discharged forward in a joining moving direction of the adhesive tape joining apparatus. Therefore, in the case of carrying out the joining processing on the horizontally long bottom face of the workpiece, even if the separated separator moves forward in a moving direction of the adhesive tape joining apparatus, it is not obstructive to the forward moving because it hangs down downward by its own weight. However, in the case of performing the joining processing on the longitudinal directed place in the workpiece, the separator moved forward in the moving direction of the adhesive tape joining apparatus is obstructive to the forward moving. Accordingly, this involves a disadvantage such that the attention to the adhesive tape joining operation gets distracted due to the operation to wave aside the separator or the joining moving speed is lowered so as to deteriorate finish of joining.

### SUMMARY OF THE INVENTION

The present invention has been made taking the foregoing problems into consideration and an object of which is to provide an adhesive tape joining apparatus that can smoothly carry out the adhesive tape joining without being distracted by the separated separator and can easily set setting of the adhesive tape.

In order to attain the aforementioned object, the present invention may include the following structure as follows:

An adhesive tape joining apparatus which supplies an adhesive tape to a joining roller while moving forward along a workpiece and joins this adhesive tape on a tape joining face of the workpiece by pressing the adhesive tape against the tape joining face, the apparatus including the followings:

a guide member which determines the position of the main body and keeps the posture of the main body with respect to the workpiece being engaged with the outer face of the workpiece which is different from the tape joining face on the main body which is moved and operated along the tape joining face of the workpiece;

a joining roller which joins the adhesive tape to the tape joining face of the workpiece by pressing the adhesive tape against the tape joining face of the workpiece and can be elastically transformed;

a tape supply roller which winds and guides the adhesive tape and leads the tape to the joining roller;

a separator guide arranged to be opposed to the tape supply roller; and

a tape guide for preventing disengagement of the tape that is fed in the tape supply roller;

wherein

a separator guide face for guiding a separator which is peeled off the adhesive tape at a region where the tape is wound of the tape supply roller in a direction different from a tape joining and moving direction is formed on the separator guide, and the separator guide can be changed between a posture for a separator guiding operation opposed to the tape supply roller and a release posture which is largely separated from the tape supply roller.

According to the adhesive tape joining apparatus of the present invention, by moving the adhesive tape joining apparatus of which position and posture are secured by the guide member along the workpiece, the adhesive tape is guided and supplied to the joining roller via the tape supply roller, and the adhesive tape pressed by the joining roller is continuously joined to the tape joining face of the workpiece. In addition, being wound around the tape supply roller, the adhesive tape turns around to be introduced to the joining roller. On the other hand, the separator does not turn around and is separated at the region where the tape is wound to move toward a separator guide. Then, the separator is guided to the separator guide face to be released in a direction that is not obstructive to joining of the tape.

In addition, at the beginning of the joining operation, the adhesive tape is guided to the tape supply roller and the joining roller via a tape guide. In this case, by changing the separate guide closed to and opposed to the tape supply roller into a release posture, the winding setting of the adhesive tape and the separation operation of the separator can be easily carried out in a wide space.

Further, in the apparatus according to the present invention, the separator guide is configured as follows:

For example, the separator guide is rotatably supported around a support point axis directed in a back and forth direction along a tape joining moving direction.

The separator guide is rotatably supported around a support point axis directed in an upper and lower direction which is orthogonal to the tape joining moving direction.

The separator guide is rotatably supported up and down around a support point axis directed in a lateral direction which is orthogonal to the tape joining moving direction.

According to this structure, the separator guide which is changed and swung into the release posture is largely separated into a lateral outside of the adhesive tape joining apparatus. In other words, the front side and the lateral outside of the tape supply roller are largely released. As a result, it is possible to easily carry out the winding setting of the adhesive tape and the separation operation of the separator in a wide space.

In addition, it is preferable that the apparatus according to the present invention further includes the following constituent elements:

A posture keeping means which stably keeps the separator guide located in the separator guide operation posture and gives an operational resistance when the posture of the separator guide is changed into the release posture.

According to this structure, the separator guide positioned at the posture for the separator guiding operation does not move to the release side without discretion. In other words, during the joining operation, a desired separator guiding operation can be effected in an appropriate manner.

It is preferable that the apparatus according to the present invention further includes the following constituent elements:

A posture keeping means which stably keeps the separator guide located in the release posture and gives an operational resistance when the separator guide is changed into the separator guide operation posture.

According to this structure, the separator guide positioned at the release posture does not come close and move to the tape supply roller without discretion and does not obstruct the setting operation of the adhesive tape.

Further, the posture keeping means can be configured by a detent mechanism to elastically engage a ball which can be moved backward elastically in an engagement hole.

According to this structure, for example, the separator guide positioned at the posture for the separator guiding operation or the release posture is not moved by a little external force and kept stably. In other words, if an operational force more than the set force is provided to the separator guide, due to elastic backward moving of a ball, a posture keeping function is released, so that the separator guide can be moved into a desired direction. In this case, since the ball which is moved backward moves on a surface of other member by point contact, the separator guide can be lightly moved.

It is preferable that the apparatus according to the present invention further includes the following constituent elements:

An abutting means for positioning the separator guide at the separator guide operation posture.

According to this structure, only by returning and moving the separator guide positioned at the release posture without difficulty till it cannot be moved, it is possible to accurately position the separator guide at a predetermined posture for the separator guiding operation. In other words, the separator guide returning operation after setting the adhesive tape can be carried out immediately, so that the separator guide can be easily treated.

In addition, the separator guide may be configured as follows:

The separator guide is configured so as to be slid in an upper and lower direction being orthogonal to the back and forth directed support point axis along the tape joining moving direction.

In this case, it is preferable that the apparatus is pressed and biased to the side of the tape guide by a compression coil spring which is externally mounted on the support point axis; and the apparatus has at least a pair of engagement projection and engage concave part, respectively, on the opposed slid face of the tape guide and the separator guide.

According to this structure, the separator guide which is changed and swung into the release posture is largely separated into the lateral outside of the adhesive tape joining apparatus. In other words, the front side and the lateral outside of the tape supply roller are largely released. As a result, it is possible to easily carry out the winding setting of the adhesive tape and the separation operation of the separator in a wide space.

In addition, it is preferable that the apparatus according to the present invention further includes the following constituent elements:

A tape positioning part which slidably supports an end of the adhesive tape at one end side of the tape guide; and

a tape guide which sandwiches the adhesive tape which is slidably supported by the tape positioning part from other end to guide running of the adhesive tape.

According to this structure, it is possible to join the adhesive tape on the workpiece with running of the adhesive tape being stabilized.

In order to attain such an object, the present invention may be configured as follows:

An adhesive tape joining apparatus which supplies an adhesive tape to a joining roller while moving forward along a workpiece and joins this adhesive tape on a tape joining face of the workpiece by pressing the adhesive tape against the tape joining face, the apparatus including the followings:

a guide member which determines the position of the main body and keeps the posture of the main body with respect to the workpiece being engaged with the outer face of the workpiece which is different from the tape joining face on the main body which is moved and operated along the tape joining face of the workpiece;

a joining roller which is configured by a pair of rollers arranged back and forth in a tape joining direction, which winds and guides the adhesive tape to be supplied, joins the adhesive tape on the tape joining face by pressing the adhesive tape on the tape joining face of the workpiece, and can be elastically transformed; wherein a front side roller has a larger diameter than a rear side roller;

a separator guide arranged to be closed to be opposed to the joining roller; and

a tape guide for preventing disengagement of the tape that is fed in the joining roller;

wherein

a separator guide face for guiding a separator which is peeled off the adhesive tape at a region where the tape is wound of the joining roller in a direction different from a tape joining and moving direction is formed on the separator guide, and the separator guide can be changed between a posture for a separator guiding operation opposed to the joining roller and a release posture which is largely separated from the joining roller.

According to this structure, since there is no tape supply roller not until the adhesive tape is introduced from the tape guide to the joining roller, this adhesive tape is not influenced by a slack due to a rotational error between the tape supply roller and the joining roller or the like. In other words, it is possible to keep a degree of tension given to the adhesive tape in a range from the tape guide to the joining roller constant. As a result, it is possible to join the adhesive tape on the workpiece stably. In addition, since a running distance from the tape guide to the joining roller can be shortened, it is possible to prevent adhesion of dust or the like to the adhesive tape after the separator is peeled off.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view of an adhesive tape joining apparatus which is mounted on a workpiece;

FIG. 2 is a partially notched front view of the adhesive tape joining apparatus which is mounted on the workpiece;

FIG. 3 is a cross sectional plan view of the adhesive tape joining apparatus which is mounted on the workpiece;

FIG. 4 is a side view of the adhesive tape joining apparatus;

FIG. 5 is a partially notched side view showing the adhesive tape joining apparatus seen from other direction;

FIG. 6 is an exploded perspective view of the adhesive tape joining apparatus;

FIG. 7 is a partially notched side view showing substantial parts showing other embodiment of a posture keeping means;

FIG. 8 is a partially notched side view showing substantial parts showing still other embodiment of the posture keeping means;

FIG. 9 is a perspective view of an embodiment which is applied for an adhesive tape joining apparatus configured in other specification;

FIG. 10 is a front view of an embodiment which is applied to the adhesive tape joining apparatus configured in other specification;

FIG. 11 is a perspective view of the adhesive tape joining apparatus configured in other specification;

FIG. 12 is a perspective view of the adhesive tape joining apparatus configured in other specification seen from other direction;

FIG. 13 is a perspective view of the adhesive tape joining apparatus configured in other specification;

FIG. 14 is a partially notched front view of the adhesive tape joining apparatus configured in other specification;

FIG. 15 is a side view of the adhesive tape joining apparatus configured in other specification;

FIG. 16 is a perspective view of the adhesive tape joining apparatus configured in other specification;

FIG. 17 is a bottom view of the adhesive tape joining apparatus configured in other specification;

FIG. 18 is a front view of the adhesive tape joining apparatus configured in other specification;

FIG. 19 is a partially notched front view of the adhesive tape joining apparatus configured in other specification;

FIG. 20 is a cross sectional plan view of the adhesive tape joining apparatus configured in other specification;

FIG. 21 is a front view of the adhesive tape joining apparatus configured in other specification;

FIG. 22 is a cross sectional plan view of the adhesive tape joining apparatus configured in other specification; and

FIG. 23 is a partially notched front view of the adhesive tape joining apparatus configured in other specification.

### DESCRIPTION OF THE PREFERRED EMBODIMENTS

An embodiment of the present invention will be described below with reference to the drawings.

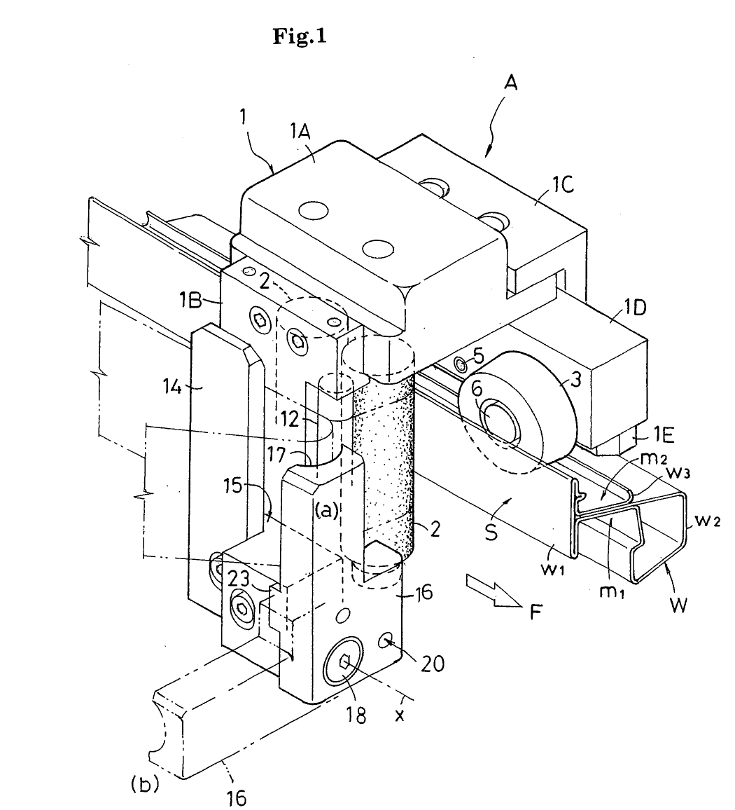

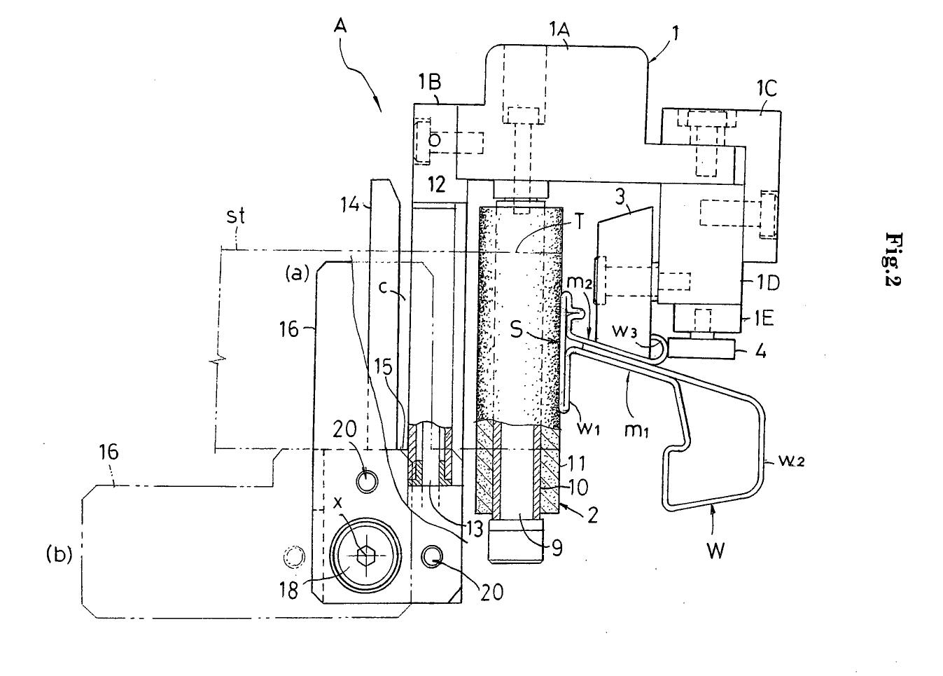

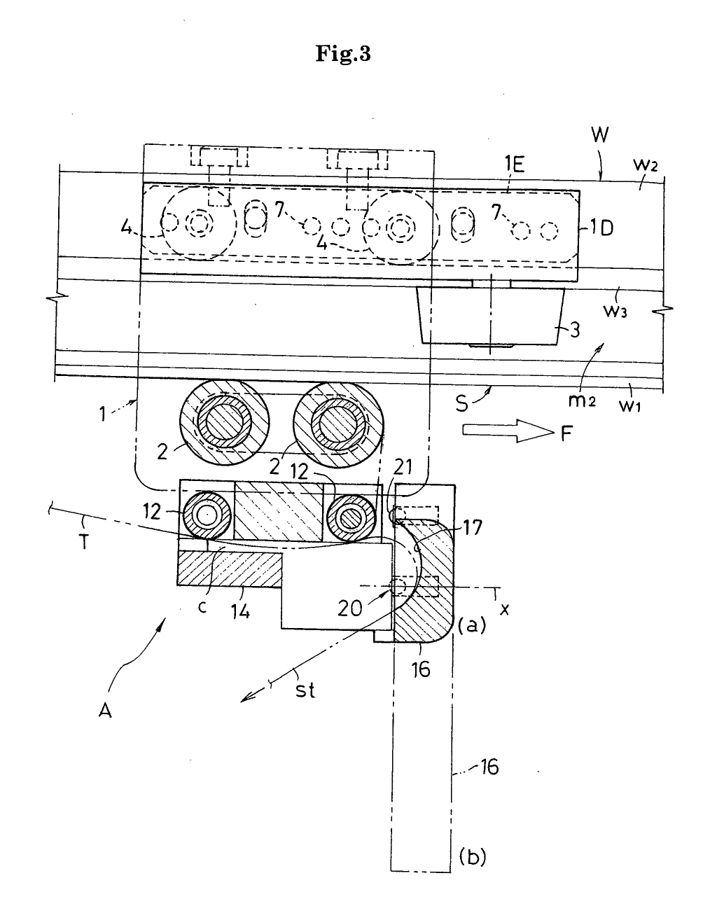

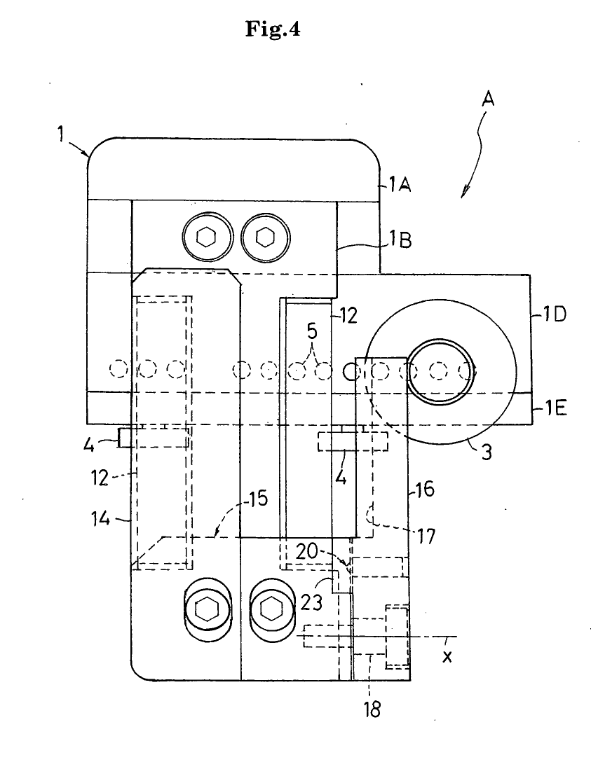

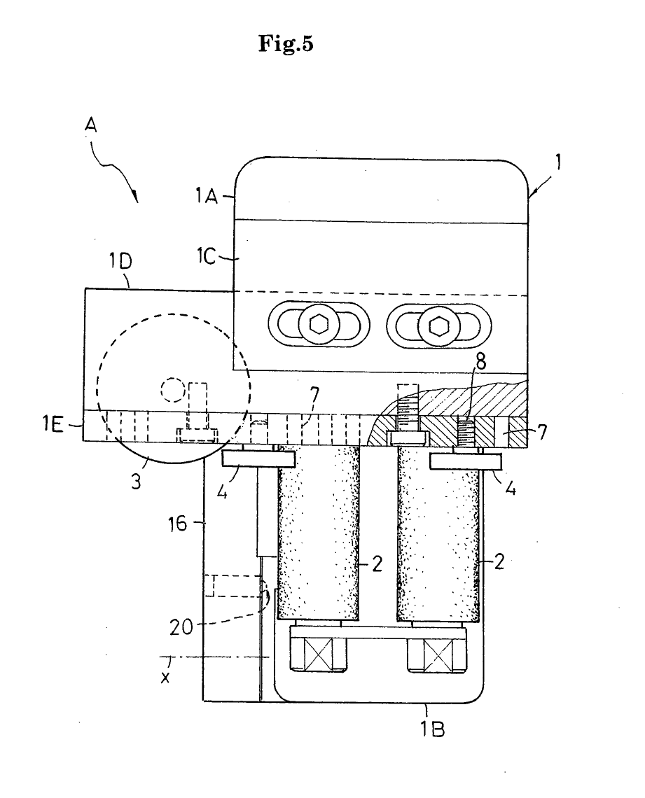

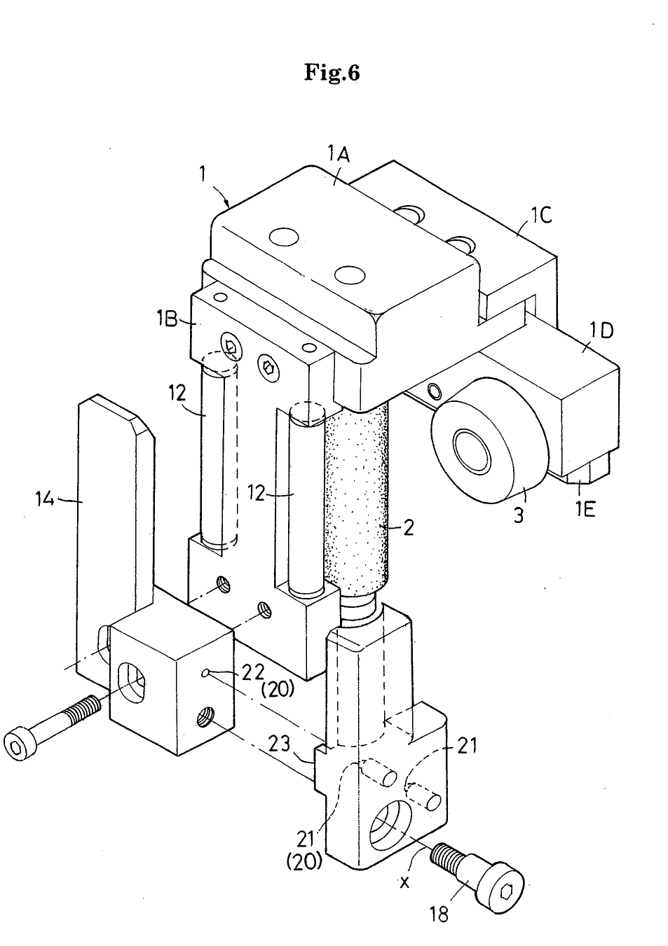

FIG. 1 is a perspective view of an adhesive tape joining apparatus A which is mounted on a workpiece W according to the present invention, FIG. 2 is a front view, FIG. 3 is its cross sectional plan view, FIG. 4 and FIG. 5 are side views of the adhesive tape joining apparatus, and FIG. 6 is an exploded perspective view of the adhesive tape joining apparatus A, respectively.

Further, a workpiece W according to the present embodiment is a door sash of an automobile, and a black adhesive tape is joined to the inner circumferential face of the inside of the automobile in place of black coating.

The workpiece W is configured by welding through presswork of a single steel plate. This workpiece W has an outer frame w1 shaped in a longitudinal wall at the lateral outside that is the outer face of the door of the work W, and the workpiece W is formed with a cross section that a hollow lateral frame w2 thrusting from this outer frame w1 toward the inside of the door (the left side in FIG. 5) is connected. Then, between a hollow region of the lateral frame w2 and the outer frame w1, a window glass mounting groove ml is formed. In addition, at right and left middle region of the upper face of the lateral frame w2, a rib w3 is protruded along the longitudinal direction of the workpiece. Between this rib w3 and the outer frame w1, a weather strip mounting groove m2 is formed. Then, the outer face at the follow region at the outer frame w1 becomes a tape joining face S. On this tape joining face S, an adhesive tape T is joined by a manual fashion by using an adhesive tape joining apparatus A according to the present invention. As the adhesive tape T, an adhesive tape with a separator that is wider than an adhesive tape of the tape joining face S is used.

The adhesive tape joining apparatus A may join the adhesive tape T being guided and engaged to the workpiece W while moving along the workpiece longitudinal direction by the manual labor. In the following description, as a matter of convenience, a direction F of joining and moving the adhesive tape joining apparatus A is called as a front direction, and a door inside and outside directions that are perpendicular to the tape joining direction are called as a lateral direction or a right and left direction.

The main body 1 of the adhesive tape joining apparatus A is formed by a hard resin material. The main body 1 is configured by a first bracket 1A shaped in a angular block, a second bracket 1B that is coupled by a bolt to be perpendicular downward to the lower end of this first bracket 1A, a third bracket 1C shaped in a L form that is coupled to right and left of other end of the first bracket 1A by a bolt so that its position can be changed, a forth bracket 1D formed in an angular rod longer back and forth, which is coupled to back and forth of the inside face of the third bracket 1C by a bolt so that its position can be changed, and a support plate 1E that is coupled to right and left of the lower face of the fourth bracket 1D so that its position can be changed.

Near one end on the lower face at one end of the first bracket 1A, a pair of back and forth rollers 2 that can freely idle around a longitudinal axial core is mounted downward like a cantilever being supported by a shaft. In addition, on the inside face at the front end of the fourth bracket 1D, as a guide member, a single guide roller 3 is mounted around a lateral core axis so as to freely idle. Further, on the support plate 1E connected along the lower face of the fourth bracket 1C, as other guide member, a pair of back and forth guide rollers 4 is mounted so as to freely idle.

The guide roller 3 is formed by a hard resin material excellent in smoothness in a slightly taper shape. Then, this guide roller 3 is inserted and engaged in a weather strip mounting groove m2 at the workpiece W to be engaged to the upper face of a lateral frame w2 so as to be in a taper shape. In addition, the guide roller 4 is also formed by a hard resin material excellent in smoothness and they are engaged with the convex curved outside face of the rib w3. In this way, since the guide rollers 3 and 4 are engaged at plural parts of the lateral frame w2 from the upper direction and the lateral side direction, the posture and the position of the adhesive tape joining apparatus A is stably kept.

Further, by adjusting the position of the fourth bracket 1D back and forth, it is possible to change and adjust the back and forth positions of the guide rollers 3 and 4. At the same time, selecting a plurality of back and forth screw holes 5 provided at the inside face of the fourth bracket 1D and screwing and mounting a support shaft 6 of the guide roller 3, it is also possible to change and adjust the back and forth position of the guide roller 3. In addition, by adjusting the position of the support plate 1E right and left, the right and left position of the guide roller 4 can be changed and adjusted by changing and adjusting the support plate 1E right and left, and further, by selecting a plurality of back and forth screw holes 7 mounted on the support plate 1E and screwing and mounting a support shaft 8, it is possible to change and adjust the back and forth position of the guide roller 4.

A joining roller 2 is configured by covering a tubular axis 10 externally fitted to a fixed core axis 9 so as to freely idle with a sponge-like elastic layer 11. In addition, with the guide rollers 3 and 4 engaged to predetermined position and posture with respect to the workpiece W, the joining roller 2 is pressed on the tape joining face S of the workpiece W while being elastically transformed in moderation.

At the back and forth of the second bracket 1B, a pair of tape supply rollers 12, which is opposed to the joining roller 2 in parallel, is supported by a shaft around a longitudinal axial core freely idling. This tape supply roller 12 is formed by a hard resin material excellent in smoothness and is supported by a fixed support shaft 13 to freely idle.

In addition, at the outside face of the second bracket 1B, a platy tape guide 14 formed by a hard resin material is attached. As shown in FIG. 2, a tape insertion gap c released back and forth and upward is formed between this tape guide 14 and the outside face of the second bracket 1B. At the bottom end of this tape insertion gap c, a tape positioning part 15 is formed, and by accepting and supporting one side edge of the adhesive tape T inserted in this tape insertion gap c by means of the tape positioning part 15, positioning of the adhesive tape T is carried out in a width direction. Further, the tape guide 14 is attached in an upper and lower direction, namely, in a tape width direction so that its position can be adjusted.

In addition, on the front end face of the tape guide 14, a separator guide 16 formed of a hard resin material is attached. This separator guide 16, as shown in FIG. 1 and FIG. 4, is arranged being opposed to the tape supply roller 12 at a small interval at a front position of the front tape supply roller 12 and this separator guide 16 is arranged slightly lower than the tape supply roller 12. Then, on its rear directed face, a separator guide face 17 which is concave curved opposed to the tape supply roller 12 is formed.

As shown in FIGS. 1 to 3, the separator guide 16 is pivotally connected around a support point x being capable of swinging via a support point axis 18 on the front face of the tape guide 14. In addition, the separator guide 16 can be switched between (a) a separator guide operation posture opposed close to the tape supply roller 12 while rising and swinging and (b) a release posture which is turned down and swung and largely released from the tape supply roller 12.

At the opposed region between the separator guide 16 and the tape guide 14, as a means for stably keeping the separator guide 16 at (a) the separator guide operation posture and (b) the release posture, a detent mechanism 20 is mounted. This detent mechanism 20, as shown in FIG. 2 and FIG. 6, is configured by two sets of balls 21 fitted to the separator guide 16 and a single engage concave part 22 formed on the front end face of the tape guide 14 at a phase of 90 degrees around the support point x. In other words, when the separator guide 16 is located at (a) the separator guide operation posture, one ball 21 is engaged with the engage concave part 22. When the separator guide 16 is located at (b) the release posture, other ball 21 is engaged with the engage concave part 22 and each posture is stably kept.

When a swinging operational force more than a keeping force of the detent mechanism 20 is given to the separator guide 16 located at (a) the separator guide operation posture or (b) the release posture, the ball 21 being engaged is elastically moved back to be run upon the front end face of the tape guide 14. After that, with light operational force, the separator guide 16 can be swung. Then, if the separator guide 16 is returned to a predetermined posture, the ball 21 which is biased by a spring is engaged to the engage concave part 22 while getting down so as to be stably kept at this posture.

Further, rising and swinging the separator guide 16 till (a) the separator guide operation posture, as shown in FIG. 4 and FIG. 6, a project piece 23 continued at the side edge of the separator guide 16 abuts against the outside face of the tape guide, so that the positioning of the separator guide 16 at (a) the separator guide operation posture is made.

The adhesive tape joining apparatus A according to the present invention is configured as described above. Next, by using the apparatus A according to the above-described embodiment, a step of joining the adhesive tape T on the workpiece W will be described below.

At first, the operator mounts the adhesive tape joining apparatus A at the joining start position of the workpiece W by using the guide rollers 3 and 4.

In the next place, inserting the adhesive tape T with a separator through the tape insertion gap c at a longitudinal posture where a separator st of the tape T is directed to a lateral outside, and then, peeling off the separator st from the front end of the adhesive tape T, the adhesive face is exposed. Then, winding and guiding the adhesive tape T with the adhesive face exposed by the tape supply roller 12, the adhesive tape T is joined on a predetermined position of the joining face S of the workpiece W. In this case, swinging the separator guide 16 in a lateral outside and keeping it at (b) the release posture, the front side of the tape supply roller 12 is largely opened so that the operation is easily carried out.

Next, rising and swinging the separator guide 16 and returning the separator guide 16 to (a) the separator guide operation posture opposed close to the tape supply roller 12, the separator st peeled off from the adhesive tape T is guided by the separator guide face 17 of the separator guide 16 to be introduced to the rear side. This completes setting of the adhesive tape.

After that, winding the adhesive tape T with the adhesive face exposed by the joining roller 4 and elastically pressing it on the joining face S, the adhesive tape joining apparatus A is moved to the front direction F by a manual fashion along the workpiece W. Due to this movement, it is possible to continuously join the adhesive tape T on the tape joining face S while positioning the adhesive tape T in a width direction.

In this case, if the adhesive tape joining apparatus A is moved to the front direction F, the adhesive tape T is relatively moved to the front direction F, and this results in that the separator st is inversely guided on the separator guide face 17 of the separator guide 16 to be fed in a direction separated from the joining roller 2. As a result, it is prevented that the peeled-off separator st is tangled by the adhesive tape T to come close to the tape joining face S or becomes a distraction of the back and forth movement of the adhesive tape joining apparatus A or the like.

In addition, the tape part protruded from the tape joining face S is tangled and joined at the upper and lower end portions of the outer frame w1 in later, and this makes the appearance of the protruded tape part the same as the appearance of the coated tape.

In addition, the right and left direction and the back and forth direction of the guide rollers 3 and 4 can be adjusted with respect to the workpiece W in a different specification according to need. Further, in accordance with change of a width of the adhesive tape T, it is possible to adjust the positions of the tape guide 14 and the separator guide 16 upward and downward.

The present invention is not limited to the above-described embodiment and the present invention can be practiced in the following forms.

(1) According to the above-described embodiment, a single engagement hole is formed on the tape guide 14 and two sets of balls 21 to be elastically engaged with this engagement hole are mounted on the separator guide 16; however, the inverse configuration is also available. In other words, mounting a single ball 21 on the tape guide 14, providing a pair of engagement holes 22 in which this ball 21 is engaged on the separator guide 16, the detent mechanism 20 for keeping the posture can be configured.

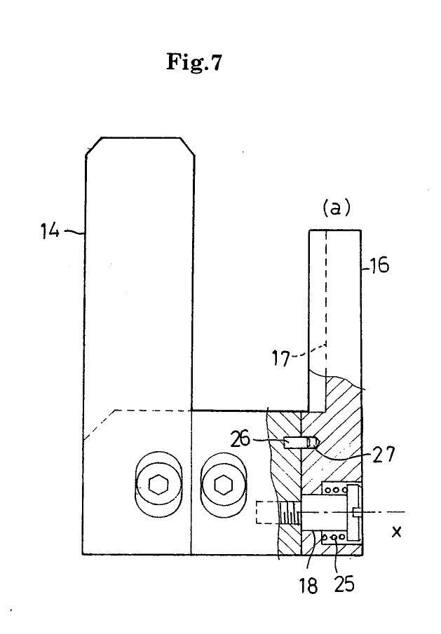

(2) As shown in FIG. 7, the separator guide 16 can be freely slid with respect to the support point axis 18. In addition, pressing and biasing the separator guide 16 to the side of the tape guide 14 by a compression coil spring 25 which is externally fitted to the support point axis 18, a single engagement projection 26 and a pair of engage concave parts 27 are formed, respectively, on the opposed slid face of the tape guide 14 and the separator guide 16. Then, when the engagement projection 26 is selected and engaged to any one of the engage concave parts 27, the detent structure that the separator guide 16 is stably kept on (a) the separator guide operation posture and (b) the release posture, respectively. In this case, the separator guide 16 is operated as follows. Pulling the separator guide 16 against the compression coil spring 25 to the front side to move it and separating the engagement projection 26 from the engage concave part 27, the separator guide 16 is operated around the support point x being capable of swinging. In other words, two action operations are carried out.

Further, a head part of the engagement projection 26 may be formed in a hemisphere. In this case, only by operating the separator guide 16 being capable of swinging, the separator guide 16 is displaced slidably to the front side against the compression coil spring 25 due to the run-upon operation of the engagement projection 26 and the engage concave part 27. In other words, as same as the above-described embodiment, the posture of the separator guide 16 can be changed by one action operation.

(3) As the format of moving the separator guide 16 into the separator guide posture and the release posture, as described above, the following formats can be considered in addition to the format of swinging the separator guide 16 around the support point x directed back and forward.

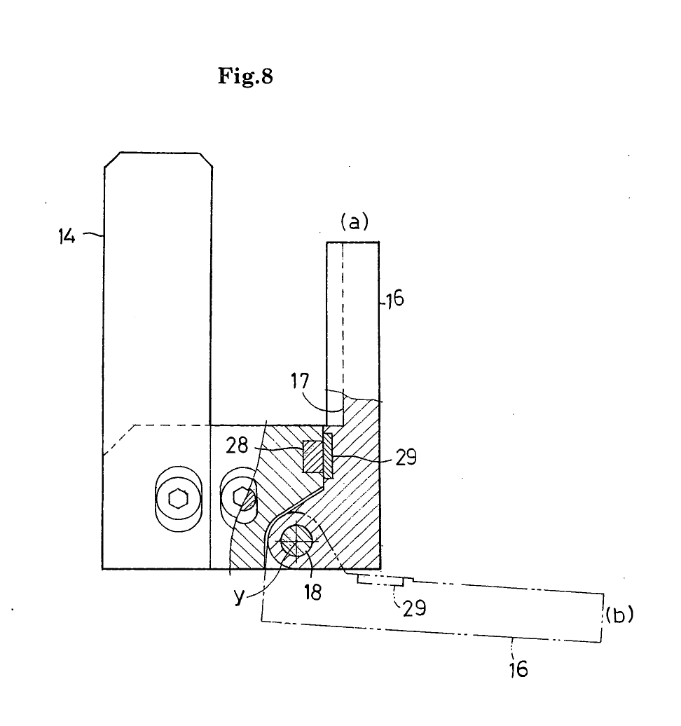

For example, as shown in FIG. 8, the separator guide 16 is pivotally coupled to the tape guide 14 via the support point axis 18 around the support point y directed right and left so as to be capable of swinging upward and downward. Then, at (a) the separator guide operation posture of raising and swinging the separator guide 16 and abutting the separator guide 16 against the front face of the tape guide 14, an iron element 29 embedded on the rear face of the separator guide 16 is attracted to a magnet element 28 embedded on the front face of the tape guide 14. According to this attraction operation, the posture can be kept. In addition, turning down and swinging the separator guide 16 to overcome the absorption force of the magnet element 28, the separator guide 16 is kept at the release posture with the base of the separator guide 16 abutting against a part of the tape guide 14.

(4) In the structure that the separator guide 16 is supported swingably between (a) the separator guide operation posture and (b) the release posture, mounting an elastic friction material such as a spring clip plate and a clip plate with a rubber at its swinging support point, an appropriate resistance may be given to the swing operation of the separator guide 16. According to this structure, it is possible to keep the separator guide 16 at the separator guide operation posture and the release posture with friction, respectively.

(5) Although it is not illustrated, the separator guide 16 may be fitted and supported to the tape guide 14 so as to be capable of sliding and moving in a back and forth direction, or in a right and left direction, or in an upper and lower direction by using a linear guide mechanism such as a guide groove, a guide rail, or a guide axis or the like. According to these structures, the present invention can be also practiced in the formation that the separator guide 16 is located at (a) the separator guide operation posture at a slide limitation that the separator guide 16 abuts against the tape guide 14 and (b) the release posture at a pulling slide limitation in a direction separated from the tape guide 14.

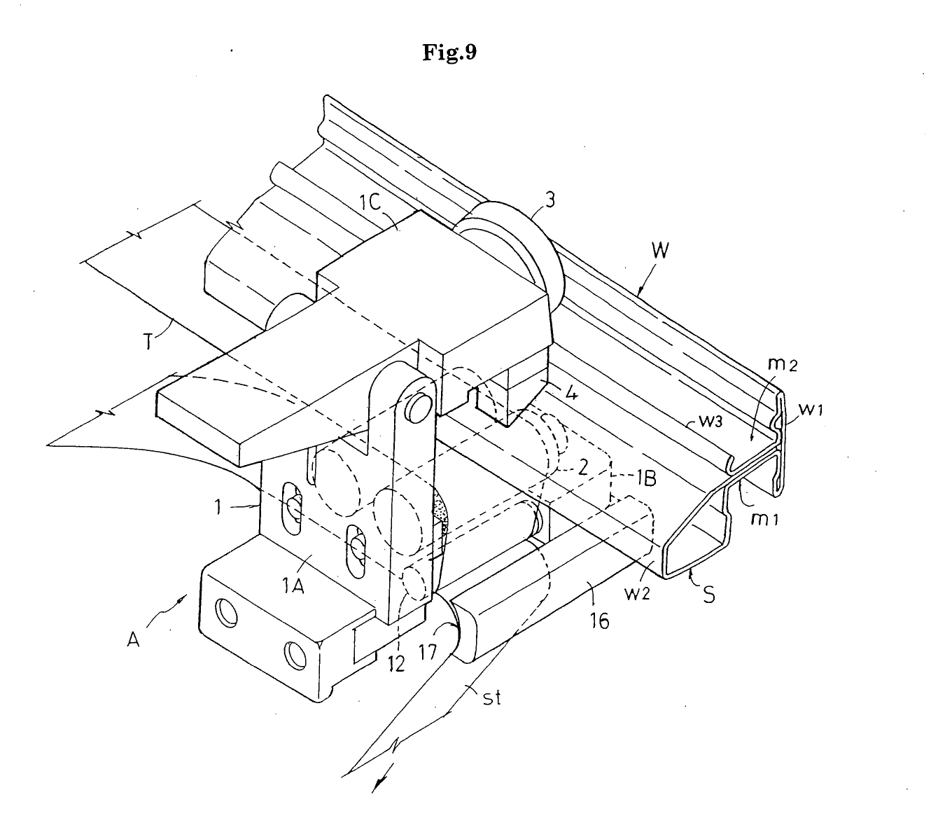

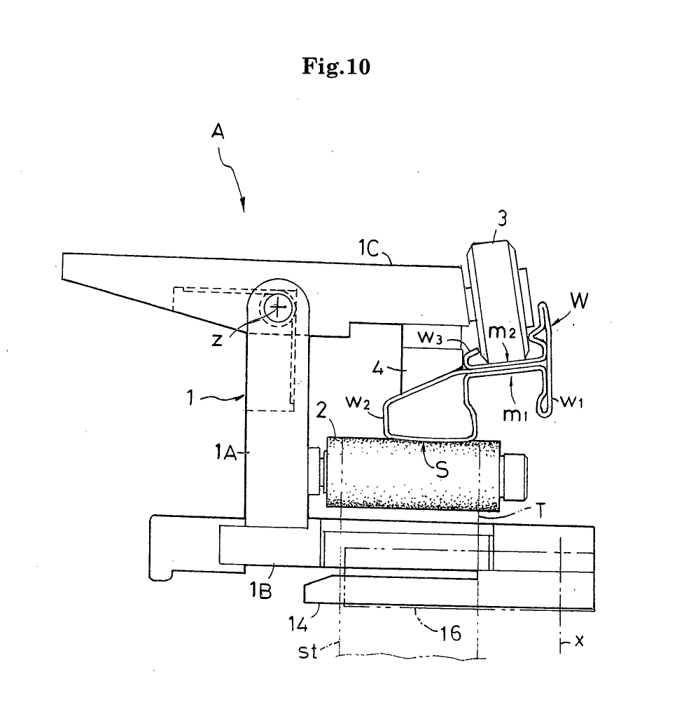

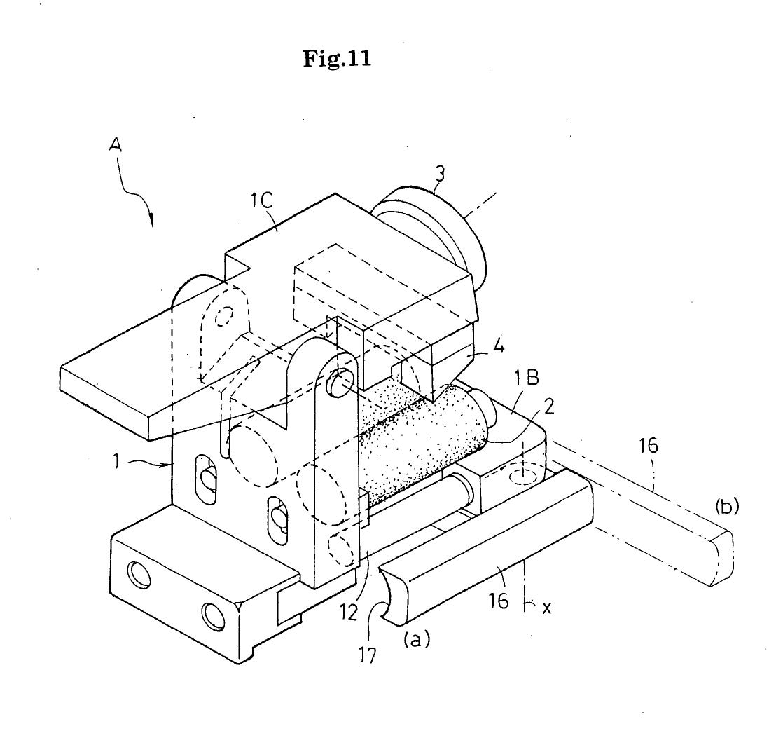

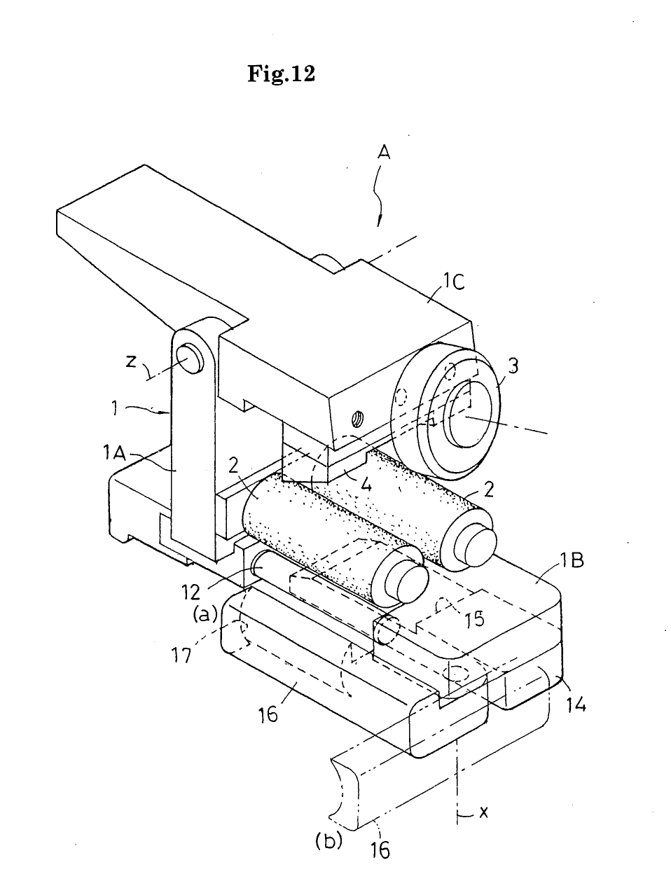

(6) As shown in FIGS. 9 to 12, the present invention can be also applied to the adhesive tape joining apparatus A in the specification to join the adhesive tape T on the lower face of the lateral frame w2 of the workpiece W. According to this example, as two kinds of guide members to keep the position and the posture with respect to the workpiece of the adhesive tape joining apparatus A, the single guide roller 3 to be engaged with a weather strip mounting groove m2 and the guide block 4 to be slid at back and forth two places on the upper face of the lateral frame w2 are used. Then, each of the guide roller 3 and the guide block 4 is mounted on the first bracket 1A, which is swung and biased slidably and downward around a back and forth support point z.

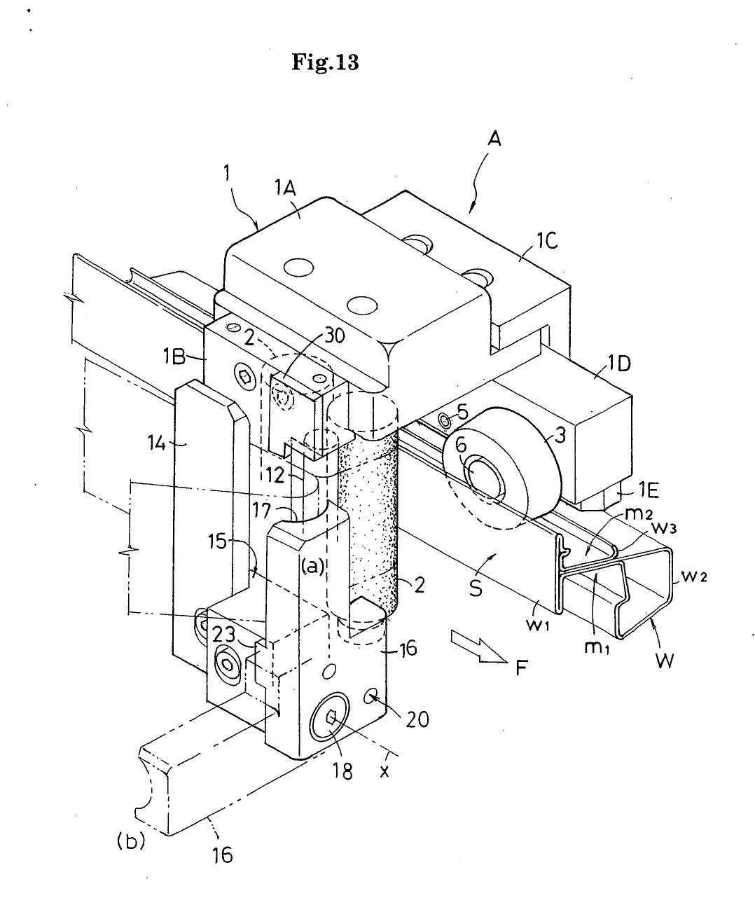

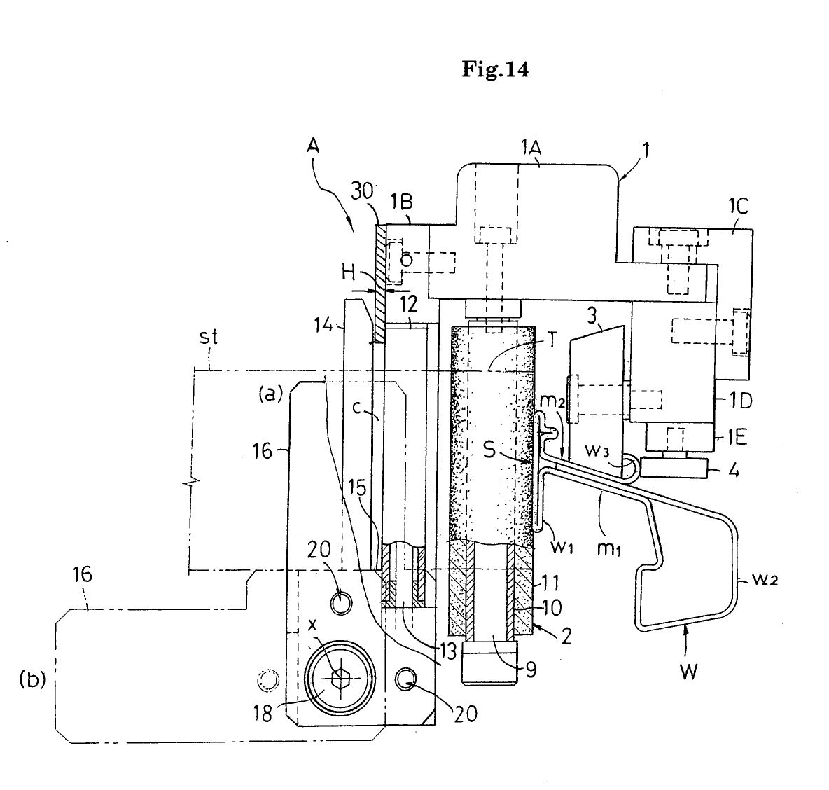

(7) As shown in FIG. 13 and FIG. 14, the apparatus according to the above-described embodiment may be provided with a tape guide 30, which guides running of the adhesive tape, at a position opposed to the tape positioning part 15 so as to sandwich the width direction of the adhesive tape T in cooperation with the tape positioning part 15. This tape guide 30 is a platy type and is attached and fixed on the outside face of the second bracket 1B.

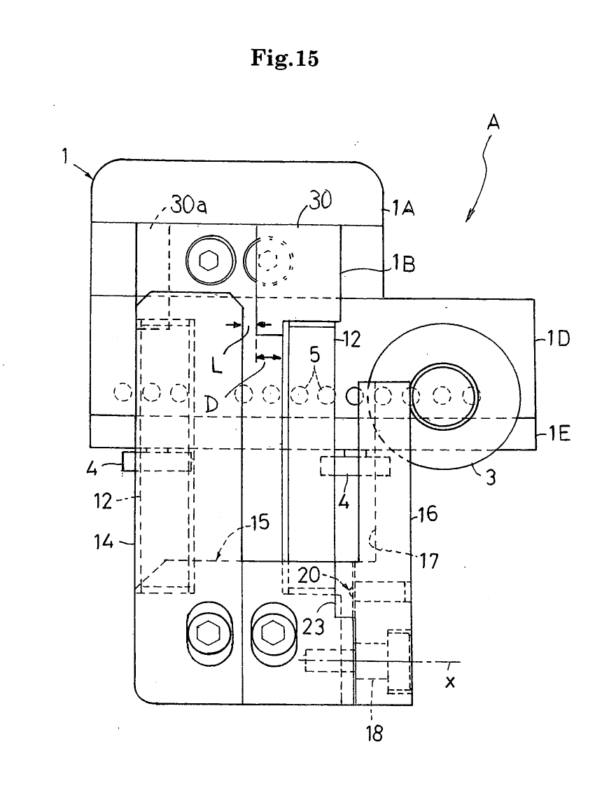

When seeing the front side of the tape guide 30 from the rear face of the apparatus shown in FIG. 15, this tape guide 30 is attached at a position at a predetermined distance L from the front end at the front side in a tape supply direction of the tape guide 14. It is preferable that this predetermined distance L is 3 mm or more. In other words, by arranging the tape guide 30 at the predetermined distance L, it is not possible to prevent mounting of the adhesive tape T to the tape guide 14 when mounting the tape in the tape guide 30.

In addition, a thickness H of the tape guide 30 is set to be thicker than the thickness of the adhesive tape T. According to the present embodiment, this thickness is set to be 2 mm or less. Further, it is preferable that an opposed part D with respect to the end edge of the adhesive tape T has a width not more than 5 mm. If the width is not more than 5 mm, when the adhesive tape T is joined on a shape curved part, easily releasing the adhesive tape T running along the tape guide 30, the rear part of the adhesive tape T can be made into a free state. In other words, the adhesive tape T can be easily treated.

Further, the tape guide 30 is attached so that setting thereof can be changed in accordance with the width of the adhesive tape T.

In addition, as shown by a broken line in FIG. 15, the tape guide 30a may be provided only at an upstream side to supply the adhesive tape T to the tape guide 14.

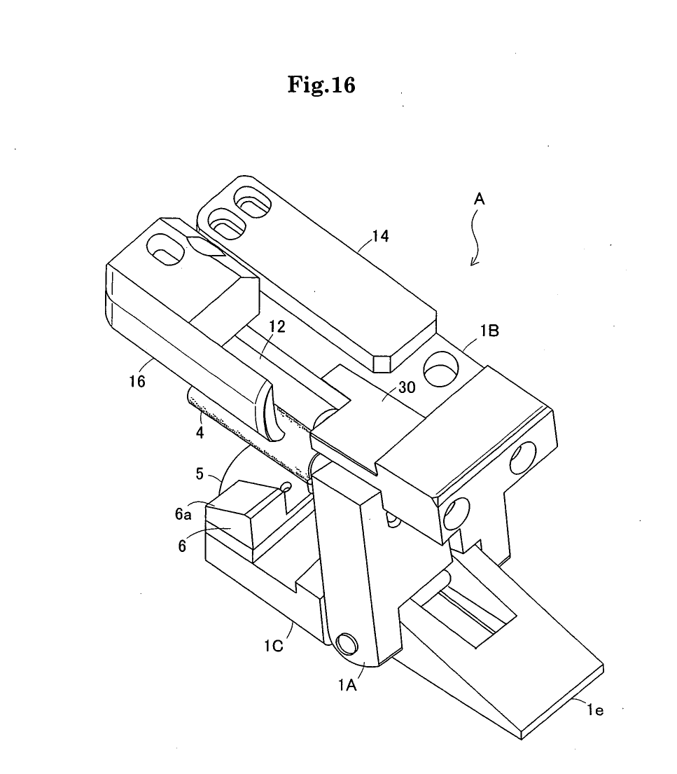

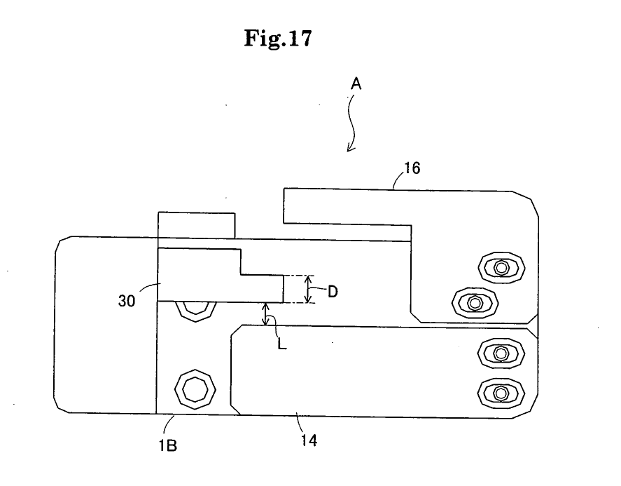

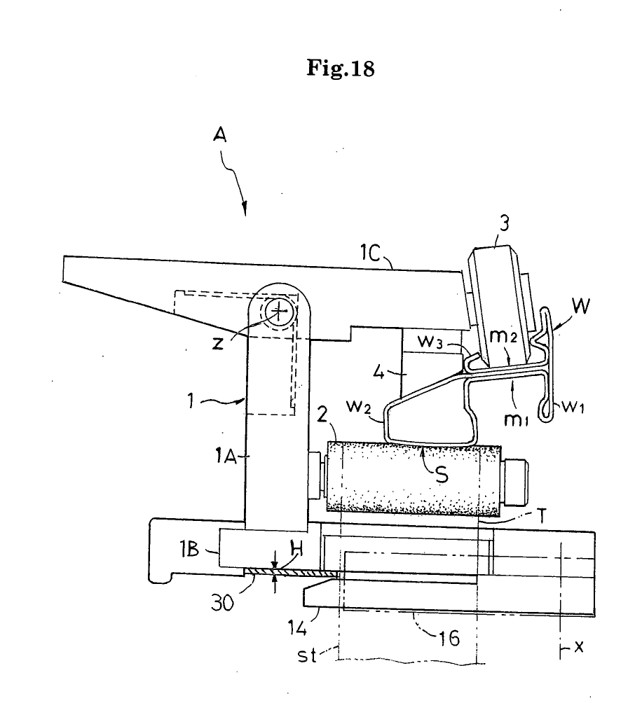

Further, the same tape guide 30 may be provided at the adhesive tape joining apparatus in the above-described other specification (6). According to this structure, as shown in FIG. 16, the tape guide 30 is attached and fixed on the outside face of the second bracket 1B. As a specific attachment position, when seeing the front side of the tape guide 30 from the rear face of the apparatus shown in FIG. 17, the tape guide 30 may be located at a position having a predetermined distance L of 3 mm or more from the end at the front side in a tape supplying direction of the tape guide 14, the thickness H shown in FIG. 18 not less than the thickness of the adhesive tape T and not more than 2 mm, and an opposed part D not more than 5 mm.

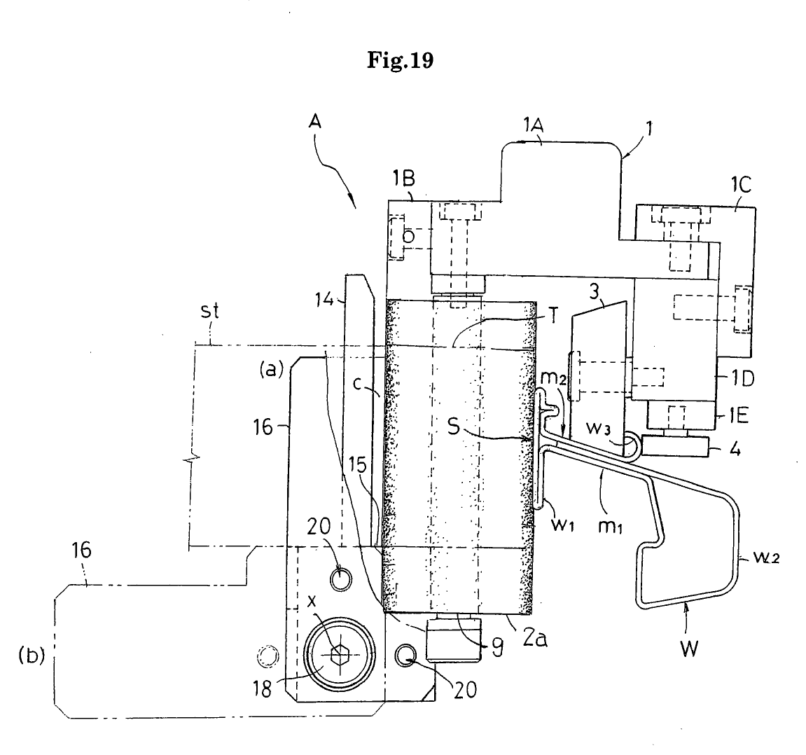

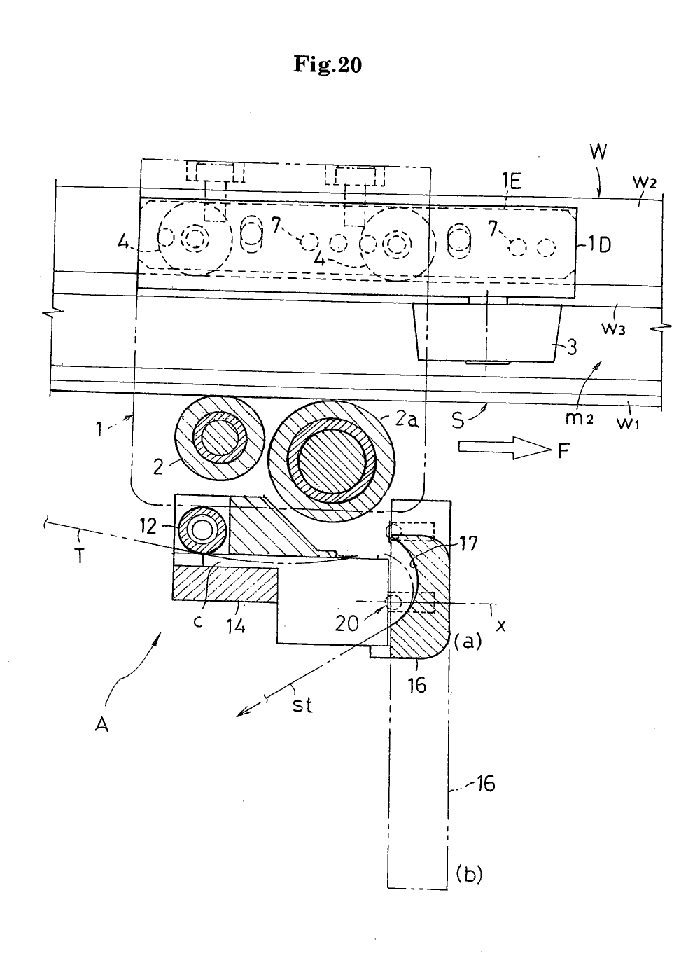

(8) According to the above-described embodiment, the adhesive tape T to be introduced from the tape guide 14 is winded and guided around the joining roller 2 via the tape supply roller 12; however, the present invention may be configured as follows. In other words, as shown in FIG. 19 and FIG. 20, the tape supply roller 12 is omitted. Then, a diameter of the joining roller 2a provided at the front side in a forward direction of this apparatus is set to be larger than a diameter of the joining roller 2b at the rear side so as to also have a function of the tape supply roller 12.

According to this structure, since there is no tape supply roller 12 till the adhesive tape T is introduced from the tape guide 14 to the joining roller 2a, this adhesive tape T is not affected by a slack due to a rotational error between the tape supply roller 12 and the joining roller 2. In other words, it is possible to keep the tension to the adhesive tape T from the tape guide 14 till the joining roller 2a constant. As a result, the adhesive tape T can be stably joined to the workpiece W. In addition, since a running distance from the tape guide 14 to the joining roller 2a can be made shorter, it is possible to prevent adhesion of a dust or the like to the adhesive tape T after the separator is peeled off.

Further, the diameter of the joining roller 2 at the front side of the apparatus according to the above-described embodiment provided with the tape supply roller 12 may be set to be larger than the diameter of the joining roller 2 at the rear side.

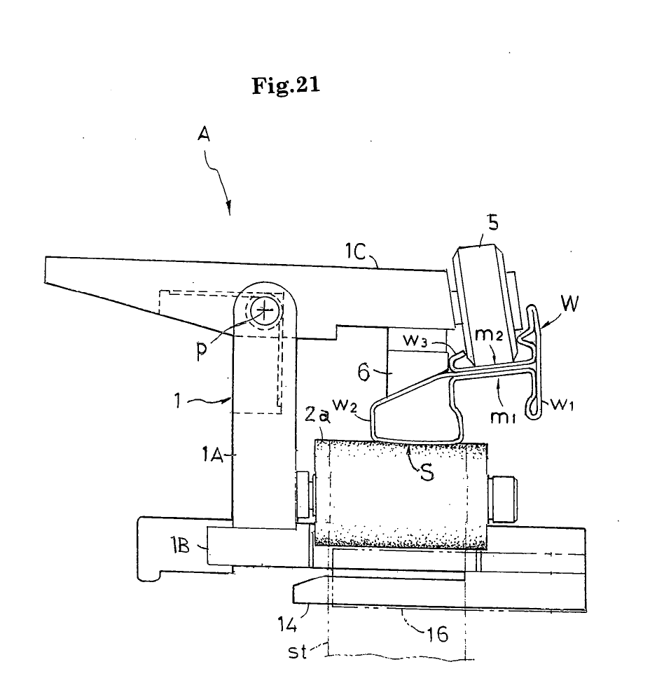

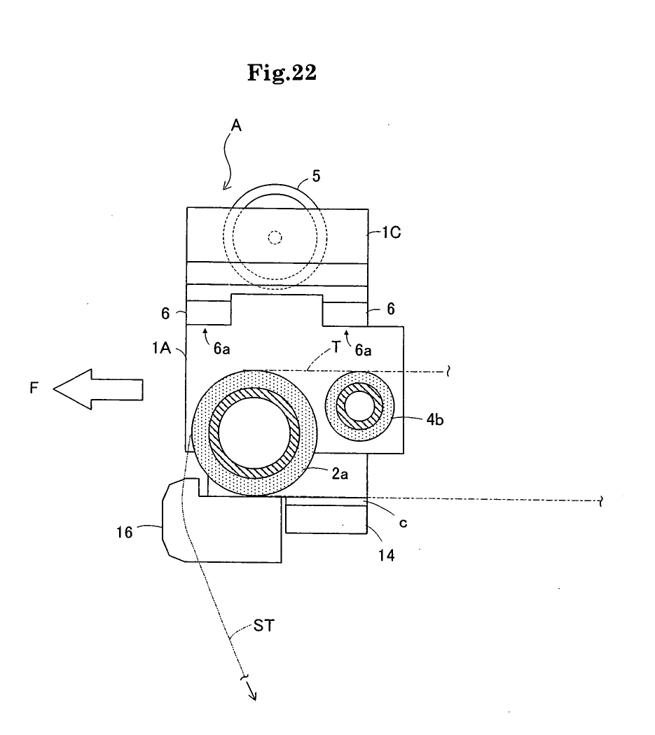

In addition, as shown in FIG. 21 and FIG. 22, in the structure that the tape supply roller 12 of the adhesive tape joining apparatus in other specification is left or omitted, the diameter of the joining roller 2a at the front side in a tape joining direction may be set to be larger than the diameter of the joining roller 2 at the rear side.

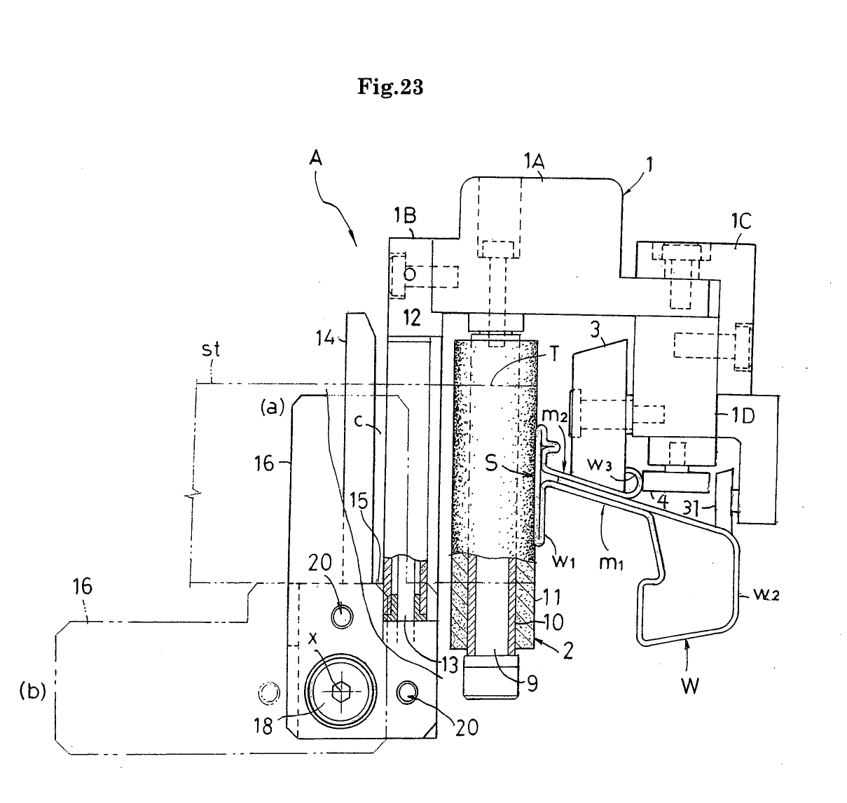

(9) According to the above-described embodiment, as shown in FIG. 23, a guide roller 31 to rotatably move on the plain surface that workpiece W is inclined downward from the rib w3 to the lateral frame w2 may be provided. According to this structure, even if a force is acted on the outside of the main body of the apparatus, the apparatus is supported by the guide roller 31, so that falling of the main body of the apparatus is prevented. In other words, in the joining step of the adhesive tape, a wobble of the main body of the apparatus is prevented, so that it is possible to join the adhesive tape T on the workpiece W stably.

The present invention may be embodied in other specific forms without departing from the spirit or essential attributes thereof and, accordingly, reference should be made to the appended claims, rather than to the foregoing specification, as indicating the scope of the invention.

What is claimed is:

1. An adhesive tape joining apparatus which supplies an adhesive tape to a joining roller while moving forward along a workpiece and joins this adhesive tape on a tape joining face of the workpiece by pressing the adhesive tape against the tape joining face, the apparatus comprising the followings:
a guide member which determines the position of the main body and keeps the posture of the main body with respect to the workpiece being engaged with the outer face of the workpiece which is different from the tape joining face on the main body which is moved and operated along the tape joining face of the workpiece;
a joining roller which joins the adhesive tape to the tape joining face of the workpiece by pressing the adhesive tape against the tape joining face of the workpiece and can be elastically transformed;
a tape supply roller which winds and guides the adhesive tape and leads the tape to the joining roller;
a separator guide arranged to be opposed to the tape supply roller; and
a tape guide for preventing disengagement of the adhesive tape that is fed in the tape supply roller;
wherein
a separator guide face for guiding a separator which is peeled off the adhesive tape at a region where the tape is wound of the tape supply roller in a direction different from a tape joining and moving direction is formed on the separator guide, and the separator guide can be changed between a posture for a separator guiding operation opposed to the tape supply roller and a release posture which is largely separated from the tape supply roller.

2. The adhesive tape joining apparatus according to claim 1, wherein
the separator guide is rotatably supported around a support point axis directed in a back and forth direction along a tape joining moving direction.

3. The adhesive tape joining apparatus according to claim 1, wherein
the separator guide is rotatably supported around a support point axis directed in an upper and lower direction which is orthogonal to the tape joining moving direction.

4. The adhesive tape joining apparatus according to claim 1, wherein
the separator guide is rotatably supported up and down around a support point axis directed in a lateral direction which is orthogonal to the tape joining moving direction.

5. The adhesive tape joining apparatus according to claim 1, wherein
the apparatus further comprising the followings:
a posture keeping means which stably keeps the separator guide located in the separator guide operation posture and gives an operational resistance when the posture of the separator guide is changed into the release posture.

6. The adhesive tape joining apparatus according to claim 5, the apparatus further comprising:
a posture keeping means which stably keeps the separator guide located in the release posture and gives an operational resistance when the separator guide is changed into the separator guide operation posture.

7. The adhesive tape joining apparatus according to claim 5, wherein
the posture keeping means is configured by a detent mechanism to elastically engage a ball which can be moved backward elastically in an engagement hole.

8. The adhesive tape joining apparatus according to claim 1, wherein
the apparatus further comprising the followings:
an abutting means for positioning the separator guide at the separator guide operation posture.

9. The adhesive tape joining apparatus according to claim 1, wherein
the separator guide is configured so as to be slid in an upper and lower direction being orthogonal to the back and forth directed support point axis along the tape joining moving direction.

10. The adhesive tape joining apparatus according to claim 9, wherein
the apparatus is pressed and biased to the side of the tape guide by a compression coil spring which is externally mounted on the support point axis; and
the apparatus has at least a pair of engagement projection and engage concave part, respectively, on the opposed slid face of the tape guide and the separator guide.

11. The adhesive tape joining apparatus according to claim 1, the apparatus further comprising:
a tape positioning part which slidably supports an end of the adhesive tape at one end side of the tape guide; and
a tape guide which sandwiches the adhesive tape which is slidably supported by the tape positioning part from other end to guide running of the adhesive tape.

12. An adhesive tape joining apparatus which supplies an adhesive tape to a joining roller while moving forward along a workpiece and joins this adhesive tape on a tape joining face of the workpiece by pressing the adhesive tape against the tape joining face, the apparatus comprising the followings:
a guide member which determines the position of the main body and keeps the posture of the main body with respect to the workpiece being engaged with the outer face of the workpiece which is different from the tape joining face on the main body which is moved and operated along the tape joining face of the workpiece;
a joining roller which is configured by a pair of rollers arranged back and forth in a tape joining direction, which winds and guides the adhesive tape to be supplied, joins the adhesive tape on the tape joining face by pressing the adhesive tape on the tape joining face of the workpiece, and can be elastically transformed; wherein a front side roller has a larger diameter than a rear side roller;
a separator guide arranged to be closed to be opposed to the joining roller; and
a tape guide for preventing disengagement of the adhesive tape that is fed in the joining roller;
wherein
a separator guide face for guiding a separator which is peeled off the adhesive tape at a region where the tape is wound of the tape supply roller in a direction different from a tape joining and moving direction is formed on the separator guide, and the separator guide can be changed between a posture for a separator guiding operation opposed to the joining roller and a release posture which is largely separated from the joining roller.

13. The adhesive tape joining apparatus according to claim 12, wherein
the separator guide is rotatably supported around a support point axis directed in a back and forth direction along a tape joining moving direction.

14. The adhesive tape joining apparatus according to claim 12, wherein
the separator guide is rotatably supported around a support point axis directed in an upper and lower direction which is orthogonal to the tape joining moving direction.

15. The adhesive tape joining apparatus according to claim 12, wherein
the separator guide is rotatably supported up and down around a support point axis directed in a lateral direction which is orthogonal to the tape joining moving direction.

16. The adhesive tape joining apparatus according to claim 12, wherein
the apparatus further comprising the followings:
a posture keeping means which stably keeps the separator guide located in the separator guide operation posture and gives an operational resistance when the posture of the separator guide is changed into the release posture.

17. The adhesive tape joining apparatus according to claim 16, the apparatus further comprising:
a posture keeping means which stably keeps the separator guide located in the release posture and gives an operational resistance when the separator guide is changed into the separator guide operation posture.

18. The adhesive tape joining apparatus according to claim 16, wherein
the posture keeping means is configured by a detent mechanism to elastically engage a ball which can be moved backward elastically in an engagement hole.

19. The adhesive tape joining apparatus according to claim 12, wherein
the apparatus further comprising the followings:
an abutting means for positioning the separator guide at the separator guide operation posture.

20. The adhesive tape joining apparatus according to claim 12, wherein
the separator guide is configured so as to be slid in an upper and lower direction being orthogonal to the back and forth directed support point axis along the tape joining moving direction.

21. The adhesive tape joining apparatus according to claim 20, wherein
the apparatus is pressed and biased to the side of the tape guide by a compression coil spring which is externally mounted on the support point axis; and
the apparatus has at least a pair of engagement projection and engage concave part, respectively, on the opposed slid face of the tape guide and the separator guide.

22. The adhesive tape joining apparatus according to claim 12, the apparatus further comprising:
a tape positioning part which slidably supports an end of the adhesive tape at one end side of the tape guide; and
a tape guide which sandwiches the adhesive tape which is slidably supported by the tape positioning part from other end to guide running of
the adhesive tape.
